(19) United States
(12) Patent Application Publication
(10) Pub. No.: US 2025/0294391 A1
(43) Pub. Date: Sep. 18, 2025

(54) DIFFERENTIAL CELL MEASUREMENT REPORTING

(71) Applicant: QUALCOMM Incorporated, San Diego, CA (US)

(72) Inventors: Hua WANG, Basking Ridge, NJ (US); Tao LUO, San Diego, CA (US); Junyi LI, Fairless Hills, PA (US)

(21) Appl. No.: 18/603,937

(22) Filed: Mar. 13, 2024

(51) Int. Cl. H04W 24/10; H04W 24/08

(52) U.S. Cl. CPC H04W 24/10; H04W 24/08

(57) ABSTRACT

Various aspects of the present disclosure generally relate to wireless communication. In some aspects, a user equipment (UE) may report a first quantity of cell measurements associated with a first differential value and a second quantity of cell measurements associated with a second differential value. Notably, reporting the quantity of cell measurements associated with a given differential value differs from reporting a single differential cell measurement value by reference to the index identifying the given differential value. For example, the quantity of cell measurements may indicate how many cell measurements are associated with the given differential value, whereas reporting the single differential cell measurement value by reference to the index may indicate that a single cell measurement value is associated with the given differential cell measurement value.

### FIELD OF THE DISCLOSURE

Aspects of the present disclosure generally relate to wireless communication and specifically relate to techniques, apparatuses, and methods for differential cell measurement reporting.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

A network node (such as a gNB, a radio unit, or the like) may provide a cell via which a user equipment (UE) can access a radio access network (RAN). A cell may have a coverage area, and UEs within the coverage area may have sufficient signal strength (that is, coverage) to access the RAN. A UE may measure signal strength of a cell by performing a cell measurement on a reference signal transmitted by the network node that provides the cell. The cell measurement may include a reference signal received power (RSRP) measurement (such as a synchronization signal RSRP (SS-RSRP) measurement or a channel state information RSRP (CSI-RSRP) measurement), a signal-to-interference-and-noise (SINR) measurement, or the like. For example, the cell measurement may be a primary cell (PCell) measurement, a primary secondary cell (PSCell) measurement, a secondary cell (SCell) measurement, or a non-serving cell measurement. Cell measurements may be used at the UE or the network node for cell selection (that is, selecting a cell on which to register after powering on), cell reselection (that is, selecting a target cell on which to register while already registered on another cell), power control, mobility (that is, selecting a target cell for a mobility operation such as a handover), and beam management (that is, selecting or refining a beam). For example, a UE may report cell measurements to the network node or another network node.

### SUMMARY

In some aspects, a method of wireless communication performed by a user equipment (UE) includes performing a plurality of cell measurements; and transmitting a report that indicates: a first quantity of cell measurements, of the plurality of cell measurements, associated with a first differential value relative to a particular cell measurement of the plurality of cell measurements, and a second quantity of cell measurements, of the plurality of cell measurements, associated with a second differential value relative to the particular cell measurement.

In some aspects, an apparatus for wireless communication at a UE includes one or more memories storing processor-executable code; and one or more processors coupled with the one or more memories, at least one processor of the one or more processors configured to cause the UE to: perform a plurality of cell measurements; and transmit a report that indicates: a first quantity of cell measurements, of the plurality of cell measurements, associated with a first differential value relative to a particular cell measurement of the plurality of cell measurements, and a second quantity of cell measurements, of the plurality of cell measurements, associated with a second differential value relative to the particular cell measurement.

In some aspects, a non-transitory computer-readable medium storing a set of instructions for wireless communication includes one or more instructions that, when executed by one or more processors of a UE, cause the UE to: perform a plurality of cell measurements; and transmit a report that indicates: a first quantity of cell measurements, of the plurality of cell measurements, associated with a first differential value relative to a particular cell measurement of the plurality of cell measurements, and a second quantity of cell measurements, of the plurality of cell measurements, associated with a second differential value relative to the particular cell measurement.

In some aspects, an apparatus for wireless communication includes means for performing a plurality of cell measurements; and means for transmitting a report that indicates: a first quantity of cell measurements, of the plurality of cell measurements, associated with a first differential value relative to a particular cell measurement of the plurality of cell measurements, and a second quantity of cell measurements, of the plurality of cell measurements, associated with a second differential value relative to the particular cell measurement.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example UE in a wireless network in accordance with the present disclosure.

FIG. 3 is a diagram illustrating an example of differential cell measurement reporting in accordance with one or more aspects of the present disclosure.

FIG. 4 is a diagram illustrating an example of a bitmap indicating quantities of cell measurements.

FIG. 5 is a diagram illustrating tables that can indicate quantities of cell measurements associated with differential values, in accordance with the present disclosure.

FIG. 6 is a diagram illustrating an example of truncation and an example of a bitmap, in accordance with the present disclosure.

FIG. 7 is a flowchart illustrating an example process performed, for example, at a UE or an apparatus of a UE that supports differential cell measurement reporting in accordance with the present disclosure.

FIG. 8 is a diagram of an example apparatus for wireless communication that supports differential cell measurement reporting in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may report cell measurements to a network node for various purposes, such as power control, mobility, or beam management. The cell measurement reporting can be Layer 1 reporting or Layer 3 reporting (such as unfiltered measurement values or filtered measurement values). Cell measurement reporting may involve some overhead. For example, a reference signal received power (RSRP) value or a signal-to-interference-and-noise (SINR) value may be selected from a large number of potential values, so several bits may be used to express the RSRP value or the SINR value. In one example, an RSRP value may be reported using 7 bits at a 1 dB resolution. It should be noted that the cell measurements described herein can also be considered beam measurements. For example, a UE may perform cell measurements on multiple synchronization signal blocks (SSBs) or channel state information reference signals (CSI-RSs), and may report the cell measurements back to the network node for beam management.

Differential cell measurement reporting (sometimes referred to as differential RSRP/SINR reporting) provides a reduction in overhead of cell measurement. In differential cell measurement reporting, a first cell measurement value is reported, and one or more differential cell measurement values are reported relative to the first cell measurement value. For example, the first cell measurement value may be a strongest cell measurement, and may be reported with 7 bits at a 1 dB resolution. A differential cell measurement value may be reported relative to the first cell measurement value, such as using a 4-bit index that indicates a differential value between the strongest cell measurement and the differential cell measurement value at a 2 dB resolution. In one example, a 4-bit index of “0000” may indicate a differential value of 0 dB≥Δ RSRP>−2 dB, meaning that the differential cell measurement value differs from the first cell measurement value by between 0 and −2 dB. Thus, overhead is reduced by 3 bits relative to explicitly reporting both the first cell measurement value and the differential cell measurement value.

As the complexity of wireless networks increases, it may be beneficial to report an increasing number of cell measurements. For example, performance of beam management may be improved when an increased number of cell measurements are reported. As another example, the increasing densification of networks may lead to a situation where the UE can report cell measurements on a large number of nearby cells. As mentioned, differential cell measurement reporting may provide a reduction in overhead of cell measurement. However, differential cell measurement reporting may provide limited overhead reduction as the number of reported cell measurements increases, since reporting N cell measurements with K potential differential values may involve N*log₂(K) bits. This increased overhead may reduce throughput or increase latency.

Various aspects relate generally to differential RSRP reporting by indicating quantities of cell measurements associated with different differential values. For example, a UE may report a first quantity of cell measurements associated with a first differential value and a second quantity of cell measurements associated with a second differential value. Notably, reporting the quantity of cell measurements associated with a given differential value differs from reporting a single differential cell measurement value by reference to the index identifying the given differential value. For example, the quantity of cell measurements may indicate how many cell measurements are associated with the given differential value (such as 0 dB≥Δ RSRP>−2 dB), whereas reporting the single differential cell measurement value by reference to the index may indicate that a single cell measurement value is associated with the given differential cell measurement value.

In some aspects, the UE may report quantities of cell measurements associated with respective differential values using a bitmap that indicates a first quantity of cell measurements and a second quantity of cell measurements. In some aspects, the bitmap may include first binary values that indicate transitions between differential values, and second binary values that indicate a quantity of cell measurements associated with a given differential value. For example, a first “0” value may indicate a transition to a given differential value, a number of consecutive “1” values between the first “0” value and a next “0” value may indicate a quantity of cell measurements corresponding to the given differential value, and the next “0” value may indicate a transition to a next differential value. Thus, overhead of reporting multiple cell measurements is reduced relative to reporting a separate four-bit index to a differential value for each reported cell measurement. In particular, reporting N cell measurements with K potential differential values may involve (N+K−1) bits, leading to overhead reduction, particularly for large values of N. For example, reporting N=7 cell measurements and K=16 differential values in this fashion may use 22 bits, which is a 21.4% overhead reduction relative to reporting single differential cell measurement values via 28 bits (calculated as N*log₂(K) bits).

In some aspects, the report may indicate a row of a table. For example, a value of the report may indicate a table index of a table, and the table may indicate quantities of cell measurements associated with respective differential values. In some aspects, each row of the table may indicate a different bitmap, such as different values of the bitmap described above. Thus, the UE may provide an indication of the bitmap described above without explicitly signaling the bitmap, thereby reducing reporting overhead relative to explicitly signaling the bitmap. Explicitly signaling the bitmap may reduce configuration overhead relative to configuring the table, or may reduce computational complexity if the UE locally computes the table.

In some aspects, the table may include only valid bitmaps. For example, the table may omit bitmaps that do not define valid quantities of cell measurements and differential values, as described elsewhere herein. Defining the table to include only valid bitmaps may reduce reporting overhead, even for smaller values of N. For example, with N=3 and K=16, reporting a table index into a table of only valid bitmaps may use 10 bits (a 16.7% overhead reduction relative to reporting single differential cell measurement values via 12 bits (calculated as N*log₂(K) bits)). As another example, with N=7 and K=16, reporting a table index into a table of only valid bitmaps may use 18 bits (a 35.7% overhead reduction relative to reporting single differential cell measurement values via 28 bits (calculated as N*log₂(K) bits)).

In some aspects, reporting quantities of cell measurements associated with respective differential values may use compression and/or truncation. For example, the UE or network node may apply a form of compression (such as Huffman encoding) to the bitmap, which may reduce reporting overhead of the report or configuration overhead of configuring a table indicating the bitmap. Additionally, or alternatively, the UE or network node may apply truncation to the bitmap, such as by dropping tailing zeroes of the bitmap, which reduces a size of the bitmap. Since compression and/or truncation may lead to variable report size, some aspects described herein provide a two-part report, in which a first part indicates a size of a second part of the report, and the second part of the report carries a (compressed and/or truncated) indication of quantities of cell measurements associated with respective differential sizes. This enables overhead reduction relative to using a fixed report size.

Some aspects described herein provide for the differential values to have different ranges. For example, a first differential value may have a 2 dB range and a second differential value may have a 4 dB range. Defining different ranges for differential values may enable overhead reduction in some scenarios. As one example, it may not be particularly beneficial to distinguish between very low RSRPs. For example, an RSRP that is 20 dB or 30 dB below a strongest RSRP may indicate very weak beam direction, and the difference between 20 dB lower and 30 dB lower may not provide useful information. Therefore, grouping all cell measurements that occur in this 10 dB range as a single quantity of cell measurements may reduce overhead relative to defining multiple “buckets” in this 10 dB range or using a uniform range for differential values.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

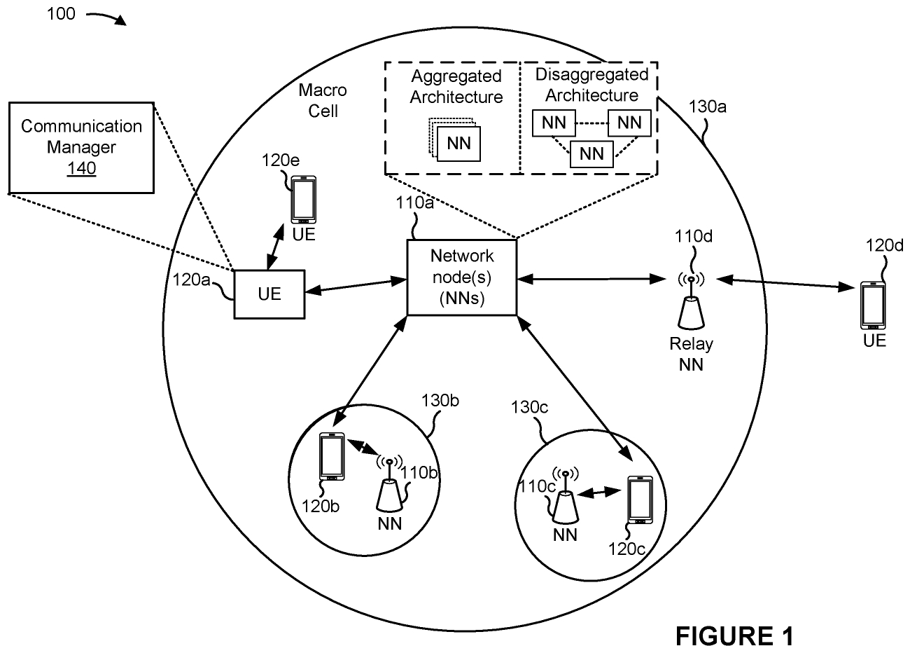

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication.

In some aspects, the UE 120 may include a communication manager 140. As described in more detail elsewhere herein, the communication manager 140 may perform a plurality of cell measurements; and transmit a report that indicates: a first quantity of cell measurements, of the plurality of cell measurements, associated with a first differential value relative to a particular cell measurement of the plurality of cell measurements, and a second quantity of cell measurements, of the plurality of cell measurements, associated with a second differential value relative to the particular cell measurement. Additionally, or alternatively, the communication manager 140 may perform one or more other operations described herein.

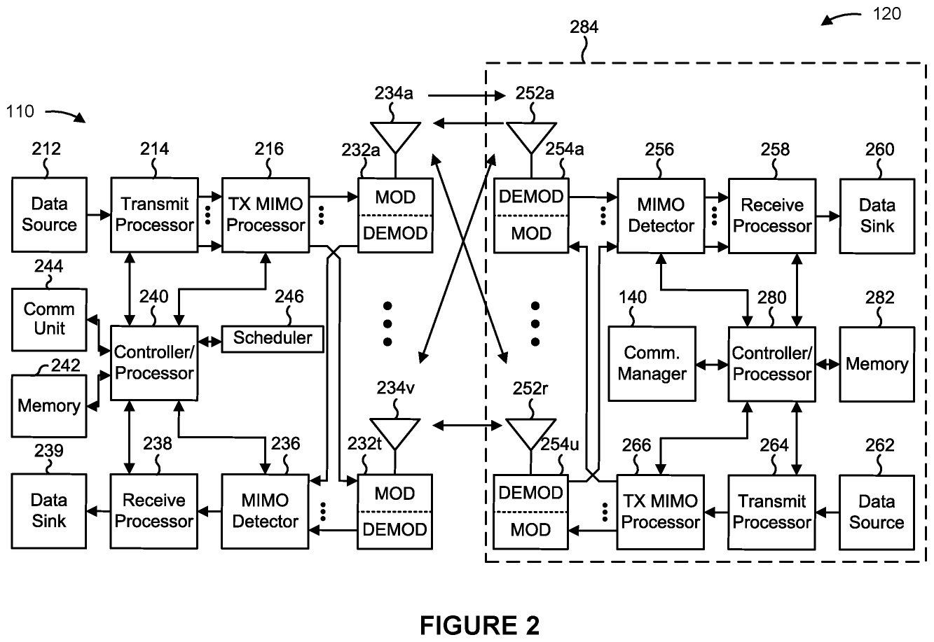

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI-RS) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use downlink control information (DCI) to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a RSRP parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include an uplink control information (UCI) communication, a MAC control element (MAC-CE) communication, an RRC communication, or another type of uplink communication. Uplink signals may be transmitted on a physical uplink shared channel (PUSCH), a physical uplink control channel (PUCCH), and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

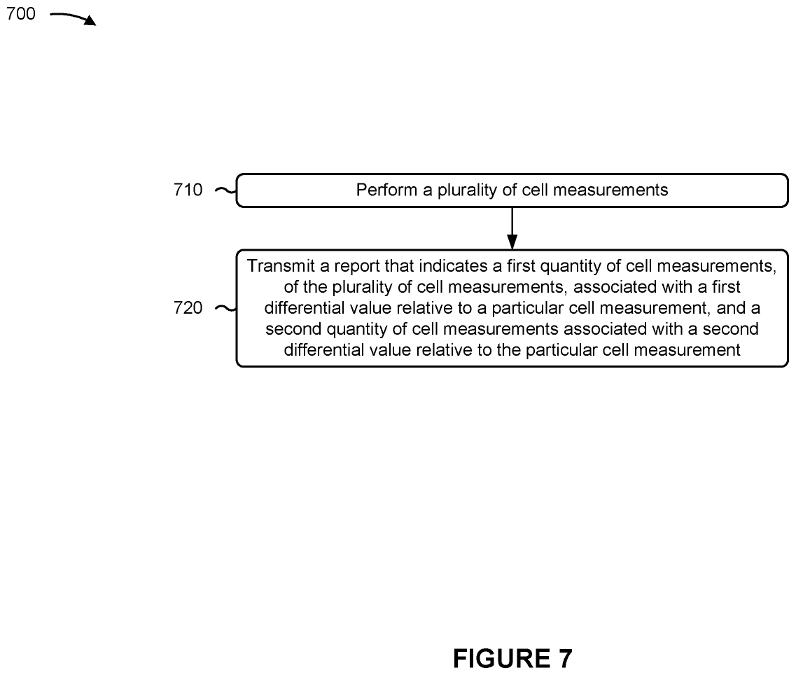

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with differential RSRP/SINR reporting, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 700 of FIG. 7 or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 700 of FIG. 7 or other processes as described herein. In some examples, executing instructions may include running the instructions, converting the instructions, compiling the instructions, and/or interpreting the instructions, among other examples.

In some examples, a UE may perform measurements of a reference signal (for example, RSRP or SINR). For example, the UE may measure a first value associated with a first reference signal and measure a second value associated with a second reference signal. The UE may compare the values. In some cases, the measurement values are indicated to the network node 110 using a set of bits. For example, the UE may be configured to report an RSRP value for a given reference signal in accordance with Table 1, below.

| Field | Bit width |
|---|---|
| RSRP | 7 |
| Differential RSRP | 4 |

Using Table 1, the UE may report an RSRP value associated with a received reference signal, such as a strongest reference signal, using the associated bit width (for example, 7 bits). As such, each value of the 7 bits may be associated with an RSRP value range that has an associated resolution (for example, 128 RSRP value ranges expressed by the 7 bits). The UE may then report a remaining RSRP of a reported set of RSRP values relative to the strongest RSRP value using 4 bits. While Table 1 indicates that the UE may use 7 bits to indicate a given RSRP value range, it is understood that any quantity of bits may be used to indicate the given RSRP value range. An example of an RSRP measurement report mapping is described with reference to Table 2, below.

TABLE 2

| Reported | Measured Quantity | |
|---|---|---|
| Value | Value of RSRP, L3 | Unit |
| RSRP_0 | RSRP < − 156 | dBm |
| RSRP_1 | −156 ≤ RSRP < −155 | dBm |
| RSRP_2 | −155 ≤ RSRP < −154 | dBm |
| RSRP_3 | −154 ≤ RSRP < −153 | dBm |
| . . . | . . . | . . . |
| RSRP_125 | −32 ≤ RSRP < −31 | dBm |
| RSRP_126 | −31 ≤ RSRP | dBm |
| RSRP_127 | Infinity | dBm |

In Table 2, each differential value (for example, RSRP_0 through RSRP_127) may be associated with a resolution (for example, range) of 1 dBm. Thus, the reporting range of synchronization signal (SS) RSRP and channel state information (CSI) RSRP for Layer 3 reporting may be defined from −156 dBm to −31 dBm with a 1 dB resolution. Similarly, the reporting range of SS-RSRP and CSI-RSRP for Layer 1 reporting may be defined from −140 to −44 dBm with 1 dBm resolution, and may be reported using reported values RSRP_16 through RSRP_113 (or RSRP_127 for “infinity”). The value of RSRP_127 may be applicable for an RSRP threshold configured by the network. While Table 2 indicates a resolution of 1 dB for each differential value, it is understood that the resolution may be of any granularity or unit. The relative accuracy of RSRP (that is, a differential value) may be defined as the RSRP measured from one cell compared to the RSRP measured from another cell on the same frequency, or between any two RSRP levels measured on the same cell in FR1.

In accordance with Table 1, the UE may report a differential value associated with a difference between multiple received reference signals using the associated bit width (for example, 4 bits). As such, each value of the 4 bits may be associated with a differential value range that has an associated resolution (for example, 16 differential RSRP value ranges expressed by the 4 bits). While Table 1 indicates that the UE may use 4 bits to indicate a given differential value, it is understood that any quantity of bits may be used to indicate the given differential value. An example of a differential RSRP measurement report mapping is described with reference to Table 3, below.

TABLE 3

| Reported | Measured Quantity Value of | |
|---|---|---|
| Value | Differential RSRP | Unit |
| DIFFRSRP_0 | 0 ≥ ΔRSRP > −2 | dB |
| DIFFRSRP_1 | −2 ≥ ΔRSRP > −4 | dB |
| DIFFRSRP 2 | −6 ≥ ΔRSRP > −8 | dB |
| DIFFRSRP_3 | −8 ≥ ΔRSRP > −10 | dB |
| . . . | . . . | . . . |
| DIFFRSRP_13 | −26 ≥ ΔRSRP > −28 | dB |
| DIFFRSRP_14 | −28 ≥ ΔRSRP > −30 | dB |
| DIFFRSRP_15 | −30 ≥ ΔRSRP | dB |

In Table 3, each reported differential value (for example, DIFFRSRP_0 through DIFFRSRP_15) may be associated with a resolution of 2 dB (for example, differential RSRP value range). While Table 3 indicates a resolution of 2 dB for each reported differential value, it is understood that the resolution may be of any decibel granularity.

Additionally, or alternatively, the UE may be configured to transmit reporting associated with reporting SINR in accordance with Table 4, below.

TABLE 4

| Field | Bit width |
|---|---|
| SINR | 7 |
| Differential SINR | 4 |

Similar to RSRP value reporting (for example, Table 2) and using Table 4, the UE may be configured to report an SINR value associated with a received reference signal using the associated bit width (for example, 7 bits). In this example, each value of the 7 bits may be associated with an SINR value range that has an associated resolution (for example, 128 SINR value ranges expressed by the 7 bits). While Table 4 indicates that the UE may use 7 bits to indicate a given SINR value range, it is understood that any quantity of bits may be used to indicate the given SINR value range. An example of an SINR measurement report mapping is described with reference to Table 5, below.

TABLE 5

| Reported Value | Measured Quantity Value of SINR | Unit |
|---|---|---|
| SINR_0 | SINR < −23 | dB |
| SINR_1 | −23 ≤ SINR < −22.5 | dB |
| SINR_2 | −22.5 ≤ SINR < −22 | dB |
| SINR_3 | −22 ≤ SINR < −21.5 | dB |
| . . . | . . . | . . . |
| SINR_125 | 39 ≤ SINR < 39.5 | dB |
| SINR_126 | 39.5 ≤ SINR < 40 | dB |
| SINR_127 | 40 ≤ SINR | dB |

In Table 5, each differential value (for example, SINR_0 through SINR_127) may be associated with a resolution (for example, range) of 0.5 dB. While Table 5 indicates a resolution of 0.5 dB for each reported value, it is understood that the resolution may be of any granularity or unit. Table 5 can be applied for L3 SS-SINR, L3 CSI-SINR, L1 SS-SINR, or L1 CSI-SINR. Thus, the reporting range of SS-SINR and CSI-SINR for Layer 1 or Layer 3 reporting may be defined from −23 dB to 40 dB with a 0.5 dB resolution. The relative accuracy of SINR (that is, a differential value) may be defined as the SINR measured from one cell compared to the SINR measured from another cell on the same frequency, or between any two SINR levels measured on the same cell in FR1.

Similar to differential RSRP value reporting (for example, Table 3) and in accordance with Table 4, the UE may report a differential value associated with a difference between multiple received reference signals using 4 bits. As such, each value of the 4 bits may be associated with a differential value range that has an associated resolution (for example, 16 differential value ranges expressed by the 4 bits). While Table 4 indicates that the UE may use 4 bits to indicate a given differential SINR value, it is understood that any quantity of bits may be used to indicate the given SINR value. An example of a differential SINR measurement report mapping is described with reference to Table 6, below.

TABLE 6

| Reported | Measured Quantity Value of | |
|---|---|---|
| Value | Differential SINR | Unit |
| DIFFSINR_0 | 0 ≥ ΔSINR > −1 | dB |
| DIFFSINR_1 | −1 ≥ ΔSINR > −2 | dB |
| DIFFSINR_2 | −2 ≥ ΔSINR > −3 | dB |
| DIFFSINR_3 | −3 ≥ ΔSINR > −4 | dB |
| . . . | . . . | . . . |
| DIFFSINR_13 | −13 ≥ ΔSINR > −14 | dB |
| DIFFSINR_14 | −14 ≥ ΔSINR> −15 | dB |
| DIFFSINR_15 | −15 ≥ ΔSINR | dB |

In Table 6, each reported differential value (for example, DIFFSINR_0 through DIFFSINR_15) may be associated with a resolution of 1 dB (for example, differential SINR value range). A measured quantity value of a differential SINR (ΔSINR) may indicate a difference in measured SINR from a largest measured SINR. While Table 6 indicates a resolution of 1 dB for each reported differential value, it is understood that the resolution may be of any decibel granularity. In some examples, the values measured for one or more reference signals may not be included in the Tables 2, 3, 5, and 6. In such examples, the UE may generate one or more additional value ranges such that the measured values may be within the generated additional value ranges.

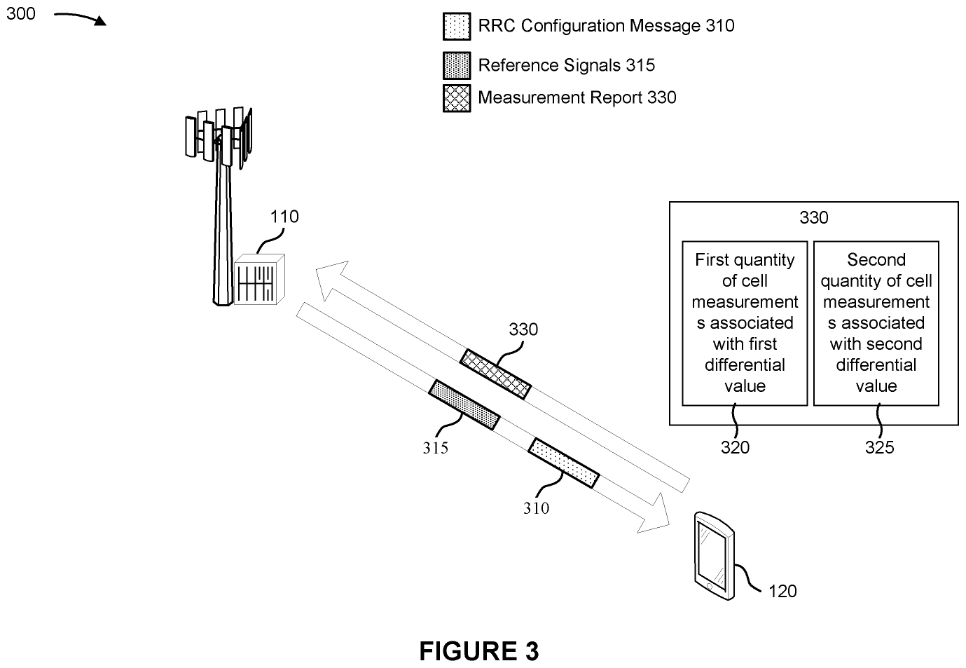

FIG. 3 is a diagram illustrating an example 300 of differential cell measurement reporting in accordance with one or more aspects of the present disclosure. Example 300 may include a UE 120 and network node 110. In some examples, the UE 120 and network node 110 may perform measurement reporting for one or more reference signals 315 using one or more reporting procedures.

As shown, the network node 110 may transmit, and the UE 120 may receive, an RRC configuration message 310. The RRC configuration message 310 may configure the UE 120 to perform cell measurements for reference signals 315 (for example, RSRP and/or SINR). The RRC configuration message 310 may also configure the UE 120 to generate and transmit a measurement report 330 that includes the cell measurements of the reference signals 315. For example, the RRC configuration message 310 may include one or more measurement objects that identify time and frequency location of a physical broadcast channel (PBCH) and CSI-RS resources for the UE 120 to measure. Additionally, or alternatively, the RRC configuration message 310 may include one or more reporting configurations that may indicate parameters associated periodic or event triggered reporting for the measurement report 330. Further, the RRC configuration message 310 may include a measurement identity that links a reporting configuration from the one or more reporting configurations to a measurement object of the one or more measurement objects. In some cases, the RRC configuration message 310 may include a quantity configuration that specifies layer 3 filtering coefficients which define the memory of the layer 3 filtering.

In some aspects, the RRC configuration message 310 may include a configuration associated with a table. For example, the RRC configuration message 310 may indicate one or more parameters to generate the table at the UE 120. As another example, the RRC configuration message 310 may define the table (such as rows of the table). Thus, the UE 120 may receive a configuration associated with (that is, defining) the table, and/or may generate the table, as described in more detail elsewhere herein.

In some aspects, the RRC configuration message 310 may indicate one or more ranges of differential values. For example, a first differential value may be configured with a first range, a second differential value may be associated with a second range, and so on. In some aspects, these ranges may be different from one another. For example, the network node 110 or the UE 120 may use an uneven interval mapping to encode a differential RSRP or SINR. As one example, the RRC configuration message 310 may indicate four differential RSRP (D-RSRP) values, all in dB: 0>=D-RSRP>−2, −2>=D-RSRP>−4, −4>=D_RSRP>−8, and −8>=D-RSRP. This type of uneven interval mapping reduces an overhead of indexing each differential value from 4 bits (assuming a uniform 2 dB range per differential value) to 2 bits. In some aspects, signaling other than the RRC configuration message 310 may indicate the one or more ranges of differential values. For example, the network node 110 may transmit, and the UE 120 may receive, signaling (for example, RRC signaling, a MAC-CE, or DCI) that indicates an index to a row of a table of ranges of differential values. This may reduce configuration overhead relative to explicitly configuring the ranges, whereas explicitly configuring the ranges may reduce overhead of indication of the ranges.

The network node 110 may transmit a set of reference signals 315 in accordance with the resources of the measurement objects indicated in the RRC configuration message 310. For example, the reference signals 315 may include a first reference signal and a second reference signal associated with PBCH and CSI-RS resources indicated in a measurement object. In some cases, the network node 110 may transmit the first reference signal using a first cell and transmit the second reference signal using a second cell. In such cases, a relative accuracy of RSRP or SINR may be expressed as a first RSRP or SINR value measured from a first cell compared to a second RSRP or SINR value from a second cell on a same frequency. In some cases, the network node 110 may transmit the first reference signal at a first frequency and the second reference signal at a second frequency using the same cell. In such cases, the relative accuracy for RSRP or SINR may be expressed as a first RSRP or SINR value measured from the cell at a first frequency and a second RSRP or SINR value measured from the cell at a second frequency.

The UE 120 may transmit, and the network node 110 may receive, the measurement report 330 indicating cell measurements (for example, RSRP or SINR) associated with a plurality of reference signals. As shown by reference number 320, the measurement report 330 may indicate a first quantity of cell measurements associated with a first differential value. As shown by reference number 325, the measurement report 330 may indicate a second quantity of cell measurements associated with a second differential value. The first quantity of cell measurements may be associated with the first differential value in that each cell measurement, of the first quantity of cell measurements, has a value that occurs in a range of the first differential value. The second quantity of cell measurements may be associated with the second differential value in that each cell measurement, of the second quantity of cell measurements, has a value that occurs in a range of the second differential value. In some aspects, the measurement report 330 may indicate a plurality of quantities of cell measurements (for example, more than two quantities of cell measurements) and respective differential values for each of these quantities of cell measurements. In some aspects, the measurement report 330 may indicate that no cell measurements are associated with a given differential value. For example, a quantity of cell measurements can include zero cell measurements.

In some aspects, the measurement report 330 may include a first part and a second part. In some aspects, the first part may have a fixed size (for example, a fixed payload). In some aspects, the first part may indicate a size (for example, number of bits) of the second part. In some aspects, the second part may have a variable size. In some aspects, the second part may indicate the first quantity of cell measurements and the second quantity of cell measurements. For example, the second part may indicate the differential RSRPs or SINRs. In some aspects, the first part may include reference signal indexes of reference signals corresponding to the reported cell measurements. In some aspects, the second part may include reference signal indexes of reference signals corresponding to the reported cell measurements. In some aspects, the first part may include information indicating a best cell measurement (for example, a best RSRP and/or a best SINR). In some aspects, the second part may include information indicating a best cell measurement (for example, a best RSRP and/or a best SINR).

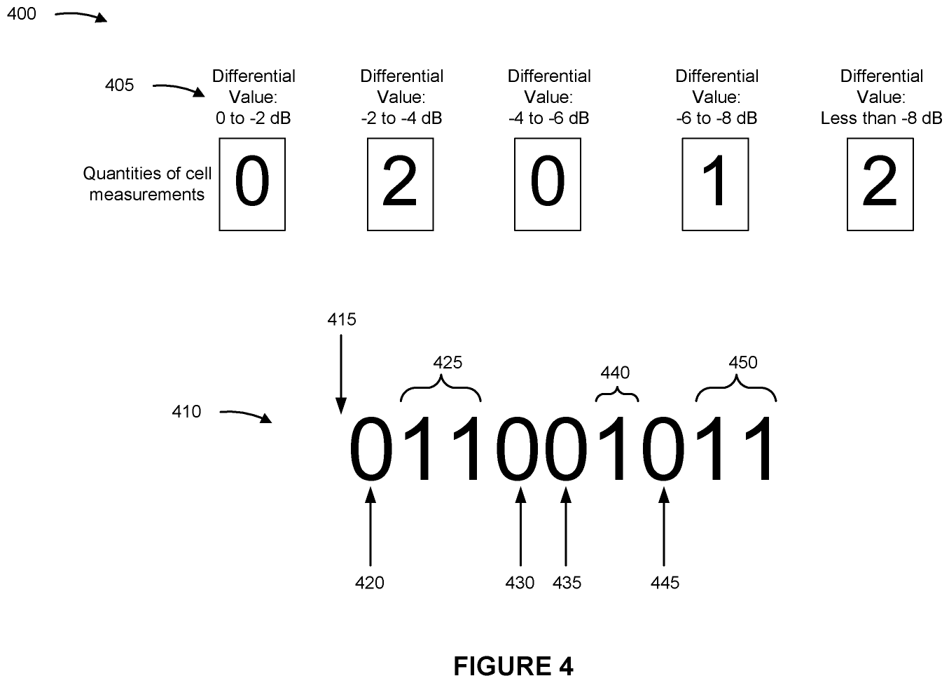

FIGS. 4, 5, and 6 provide examples of indication of quantities of cell measurements associated with respective differential values, as shown with regard to reference numbers 320 and 330 of FIG. 3.

FIG. 4 is a diagram illustrating an example 400 of a bitmap indicating quantities of cell measurements. Example 400 illustrates five differential values 405 (that is, K=5). A number corresponding to each differential value indicates a quantity of cell measurements associated with (for example, in a range of) the differential value. For example, a first differential value (having a range of 0 to −2 dB) is associated with no cell measurements, whereas a second differential value (having a range of −2 to −4 dB) is associated with 2 cell measurements. The quantities of cell measurements may belong to a plurality of cell measurements performed by a UE 120. As shown, the quantities of cell measurements sum to 5 (that is, N=5).

A bitmap 410 may indicate the quantities of cell measurements associated with each differential value. For example, there may be a one-to-one mapping from a pattern of distribution of N cell measurements among K differential values (that is, a quantity of cell measurements associated with each differential value) to a binary sequence of length N+K−1, where the bitmap 410 is the binary sequence. A bit set to first binary value (in example 400, “0”) may indicate a transition from one differential value to the next differential value. A quantity of consecutive bits set to a second binary value (in example 400, “1”) may indicate a quantity of cell measurements corresponding to a differential value.

As shown by reference number 415, the bitmap 410 is not initialized to “1” since a first differential value (0 to −2 dB) is associated with no cell measurements. As shown by reference number 420, “0” indicates a transition from the first differential value to a second differential value (−2 to −4 dB), which is associated with 2 cell measurements. Thus, as shown by reference number 425, two consecutive “is” indicate the quantity of 2 cell measurements. As shown by reference number 430, “0” indicates a transition from the second differential value to a third differential value (−4 to −6 dB), which is associated with no cell measurements. Thus, as shown by reference number 435, another “0” indicates a transition from the third differential value to a fourth differential value (−6 to −8 dB), which is associated with 1 cell measurement. As shown by reference number 440, a single “1” indicates the quantity of 1 cell measurement. As shown by reference number 445, “0” indicates a transition from the fourth differential value to a fifth differential value (less than −8 dB), which is associated with 2 cell measurements. As shown by reference number 450, two consecutive “is” indicate the quantity of 2 cell measurements.

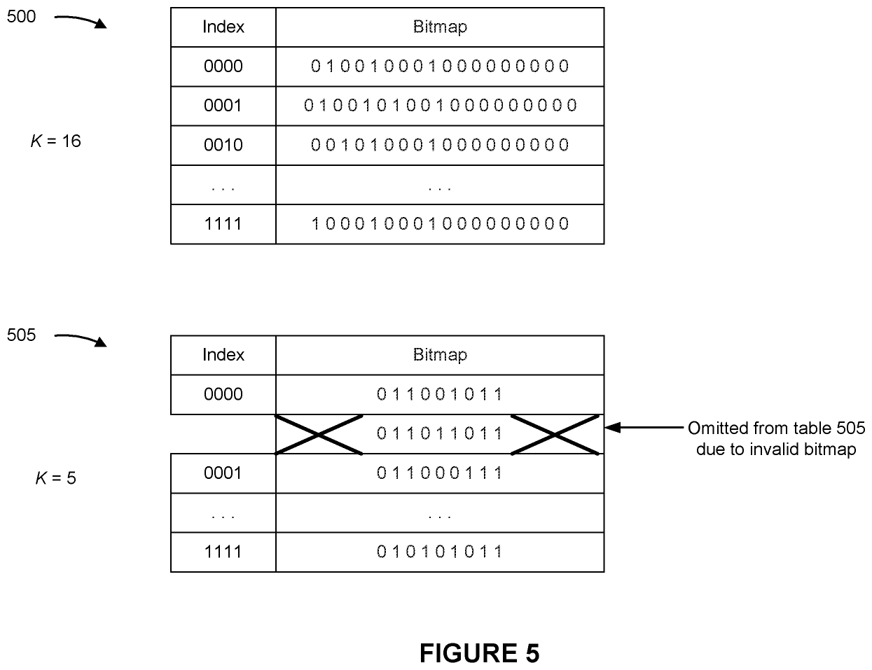

FIG. 5 is a diagram illustrating tables 500 and 505 that can indicate quantities of cell measurements associated with differential values, in accordance with the present disclosure. Each row of tables 500 and 505 indicates a table index and a corresponding bitmap. The bitmap is described in more detail in connection with FIG. 4 with regard to bitmap 410. Table 500 indicates bitmaps for 16 differential values (K=16) and 3 total cell measurements corresponding to the 16 differential values (N=3), and table 505 indicates bitmaps for 5 differential values (K=5) and 5 total cell measurements corresponding to the 5 differential values (N=5). A UE may transmit a report (for example, measurement report 330) that includes a value with a table index indicating a row of a table (such as table 500 or 505). A network node may identify the corresponding bitmap according to the table and the table index. A bitmap, such as a bitmap indicated by Table 500 or Table 505, may be referred to as a codeword. For example, “bitmap” and “codeword” may be interchangeable as used herein.

In table 505, invalid bitmaps are excluded from the table 505. An invalid bitmap may be a bitmap that defines an impossible distribution of cell measurements to differential values. A valid bitmap for K differential values and N cell measurements may include K−1 first binary values (for example, K−1 zeroes, in the examples provided herein) and N second binary values (for example, N ones, in the examples provided herein). An invalid bitmap for K differential values and N cell measurements may be any bitmap that is not a valid bitmap.

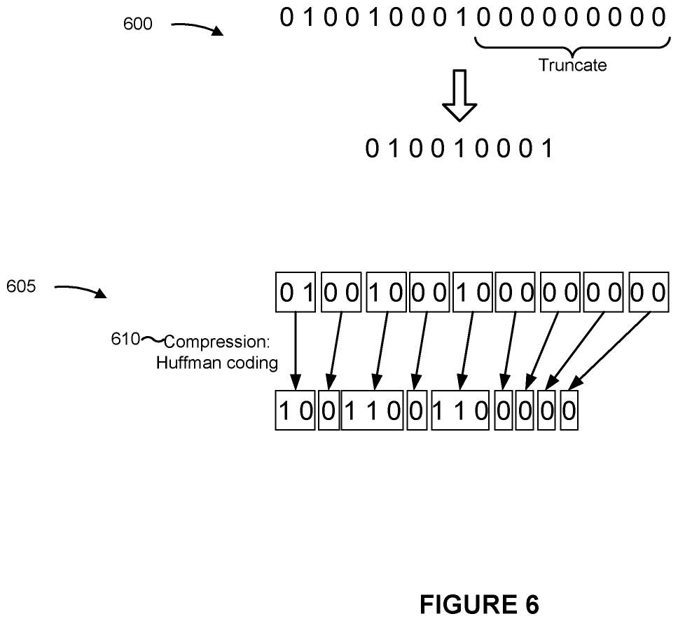

FIG. 6 is a diagram illustrating an example 600 of truncation and an example 605 of a bitmap (such as bitmap 410 or a bitmap of FIG. 5), in accordance with the present disclosure. In example 600, one or more tailing zeroes of a bitmap are truncated to form a truncated bitmap. For example, after generating a bitmap that indicates a distribution of cell measurements to differential values, the UE may truncate tailing zeroes of the bitmap. As shown, a bitmap 0 1 0 0 1 0 0 0 1 0 0 0 0 0 0 0 0 0 is truncated to 0 1 0 0 1 0 0 0 1.

In example 605, Huffman coding is applied to compress the bitmap and generate a compressed bitmap. Huffman coding provides lossless data compression of a bit sequence using variable-length codes that are derived according to an estimated probability or frequency of occurrence for each possible value of the bit sequence. For example, more common bit sequences may be mapped to shorter codes. In example 605, with N=3 and K=16, Huffman coding can be performed with bit sequences of “00” encoded as 0, bit sequences of “01” encoded as 10, bit sequences of “10” encoded as 110, and bit sequences of “11” encoded as 111. This compression is shown by reference number 610. As shown, an input bitmap of 0 1 0 0 1 0 0 0 1 0 0 0 0 0 0 0 0 0 may be compressed to 1 0 0 1 1 0 0 1 1 0 0 0 0 0, thereby reducing overhead.

In some aspects, the UE may perform both compression and truncation. For example, a bitmap (such as 0 1 0 0 1 0 0 0 1 0 0 0 0 0 0 0 0 0) may first be truncated (such as to 0 1 0 0 1 0 0 0 1 0), then may be compressed (such as via Huffman coding to 1 0 0 1 1 0 0 1 1 0). As another example, a bitmap (such as 0 1 0 0 1 0 0 0 1 0 0 0 0 0 0 0 0 0) may first be compressed (such as via Huffman coding to 1 0 0 1 1 0 0 1 1 0 0 0 0 0), then may be truncated (such as to 1 0 0 1 1 0 0 1 1).

It can be seen that truncation and/or compression may lead to a variable size of measurement report. In some aspects, the UE may transmit the measurement report as a first part and a second part, as described elsewhere herein, which may reduce overhead and enable size reduction relative to a fixed-size report.

In some aspects, a receiver (e.g., network node 110) may receive the measurement report. In some aspects, the measurement report may include the compressed and/or truncated bitmap. In some aspects, the receiver may de-truncate a truncated bitmap, for example, by appending values such that the bitmap has a length of N+K−1. In some aspects, the receiver may decompress a compressed bitmap. For example, if Huffman coding is used, the receiver may step through the compressed bitmap (starting, for example, at a leftmost bit) and replace encoded bit sequences with corresponding bit sequences. For example, bit sequences of 0 may be replaced with “00”, bit sequences of 10 may be replaced with “01”, bit sequences of 110 may be replaced with “10”, and bit sequences of 111 may be replaced with “11”. In some aspects, the receiver may identify differential values indicated by the bitmap (after decompression and/or de-truncation). For example, the receiver may step to a next differential value at each occurrence of a “0”, and may count a number of consecutive “is” corresponding to each differential value. In some aspects, the receiver may identify differential values based on a table index. For example, the table index may indicate the bitmap, and the receiver may identify the differential values according to the bitmap as described above. The receiver may perform an operation based on the differential values. For example, a network node may configure a mobility operation or a serving beam switch according to the differential values.

FIG. 7 is a flowchart illustrating an example process 700 performed, for example, at a UE (such as UE 120) or an apparatus of a UE that supports differential cell measurement reporting in accordance with the present disclosure.

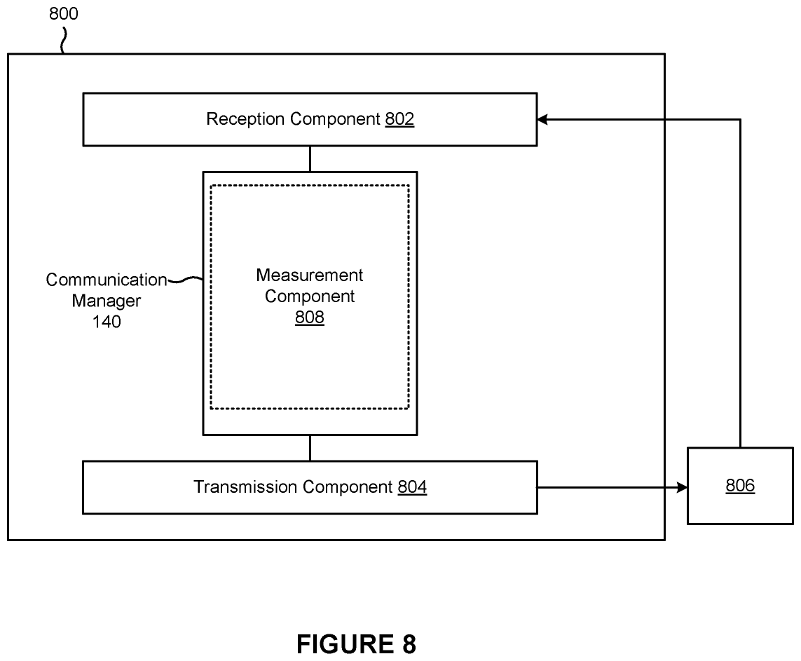

As shown in FIG. 7, in some aspects, process 700 may include performing a plurality of cell measurements (block 710). For example, the UE (such as by using communication manager 140 or measurement component 808, depicted in FIG. 8) may perform a plurality of cell measurements, as described above.

As further shown in FIG. 7, in some aspects, process 700 may include transmitting a report that indicates: a first quantity of cell measurements associated with a first differential value relative to a particular cell measurement of the plurality of cell measurements, and a second quantity of cell measurements associated with a second differential value relative to the particular cell measurement (block 720). For example, the UE (such as by using communication manager 140 or transmission component 804, depicted in FIG. 8) may transmit a report that indicates: a first quantity of cell measurements, of the plurality of cell measurements, associated with a first differential value relative to a particular cell measurement of the plurality of cell measurements, and a second quantity of cell measurements, of the plurality of cell measurements, associated with a second differential value relative to the particular cell measurement, as described above. The particular cell measurement may be a strongest cell measurement, such as a strongest RSRP or a strongest SINR.

Process 700 may include additional aspects, such as any single aspect or any combination of aspects described below or in connection with one or more other processes described elsewhere herein.

In a first additional aspect, the report includes a bitmap that indicates the first quantity of cell measurements and the second quantity of cell measurements.

In a second additional aspect, alone or in combination with the first aspect, a first binary value in the bitmap indicates a transition from the first differential value to the second differential value, and a quantity of consecutive second binary values in the bitmap indicates the second quantity of cell measurements.

In a third additional aspect, alone or in combination with one or more of the first and second aspects, the bitmap is a truncated bitmap.

In a fourth additional aspect, alone or in combination with one or more of the first through third aspects, process 700 includes compressing the bitmap prior to transmitting the report.

In a fifth additional aspect, alone or in combination with one or more of the first through fourth aspects, compressing the bitmap further comprises generating the bitmap via Huffman compression.

In a sixth additional aspect, alone or in combination with one or more of the first through fifth aspects, compressing the bitmap further comprises generating the bitmap via Huffman compression of a truncated bitmap.

In a seventh additional aspect, alone or in combination with one or more of the first through sixth aspects, the report includes a first part and a second part, wherein the first part indicates a size of the second part, and the second part indicates the first quantity of cell measurements and the second quantity of cell measurements.

In an eighth additional aspect, alone or in combination with one or more of the first through seventh aspects, the report includes a value that indicates the first quantity of cell measurements and the second quantity of cell measurements.

In a ninth additional aspect, alone or in combination with one or more of the first through eighth aspects, the value indicates a table index of a table, wherein the table index corresponds to a row of the table indicating the first quantity of cell measurements and the second quantity of cell measurements.

In a tenth additional aspect, alone or in combination with one or more of the first through ninth aspects, the row indicates a bitmap, wherein a first binary value in the bitmap indicates a transition from the first differential value to the second differential value, and a quantity of consecutive second binary values in the bitmap indicate the second quantity of cell measurements.

In an eleventh additional aspect, alone or in combination with one or more of the first through tenth aspects, each row of the table corresponds to a valid bitmap for indication of transitions between differential values and numbers of cell measurements.

In a twelfth additional aspect, alone or in combination with one or more of the first through eleventh aspects, process 700 includes receiving a configuration associated with the table.

In a thirteenth additional aspect, alone or in combination with one or more of the first through twelfth aspects, process 700 includes generating the table.

In a fourteenth additional aspect, alone or in combination with one or more of the first through thirteenth aspects, the first differential value corresponds to a first range of cell measurement values and the second differential value corresponds to a second range of cell measurement values.

In a fifteenth additional aspect, alone or in combination with one or more of the first through fourteenth aspects, the first range of cell measurement values has a first size and the second range of cell measurement values has a second size different than the first size.

In a sixteenth additional aspect, alone or in combination with one or more of the first through fifteenth aspects, process 700 includes receiving a configuration that indicates at least one of the first range of cell measurement values or the second range of cell measurement values.

In a seventeenth additional aspect, alone or in combination with one or more of the first through sixteenth aspects, the plurality of cell measurements comprises at least one of a reference signal received power measurement or a signal to interference and noise ratio measurement.

In an eighteenth additional aspect, alone or in combination with one or more of the first through seventeenth aspects, the first quantity of cell measurements comprises multiple cell measurements.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports differential cell measurement reporting in accordance with the present disclosure. The apparatus 800 may be a UE, or a UE may include the apparatus 800. In some aspects, the apparatus 800 includes a reception component 802, a transmission component 804, and a communication manager 140, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIGS. 3-6. Additionally or alternatively, the apparatus 800 may be configured to and/or operable to perform one or more processes described herein, such as process 700 of FIG. 7. In some aspects, the apparatus 800 may include one or more components of the UE described above in connection with FIG. 2.

The reception component 802 may receive communications, such as reference signals, control information, and/or data communications, from the apparatus 806. The reception component 802 may provide received communications to one or more other components of the apparatus 800, such as the communication manager 140. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, one or more modems, one or more demodulators, one or more MIMO detectors, one or more receive processors, one or more controllers/processors, and/or one or more memories of the UE described above in connection with FIG. 2.

The transmission component 804 may transmit communications, such as reference signals, control information, and/or data communications, to the apparatus 806. In some aspects, the communication manager 140 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 804 may be co-located with the reception component 802 in one or more transceivers.

The communication manager 140 may perform a plurality of cell measurements. The communication manager 140 may transmit or may cause the transmission component 804 to transmit a report that indicates a first quantity of cell measurements, of the plurality of cell measurements, associated with a first differential value relative to a particular cell measurement of the plurality of cell measurements, and a second quantity of cell measurements, of the plurality of cell measurements, associated with a second differential value relative to the particular cell measurement. In some aspects, the communication manager 140 may perform one or more operations described elsewhere herein as being performed by one or more components of the communication manager 140.

The communication manager 140 may include one or more controllers/processors and/or one or more memories, of the UE described above in connection with FIG. 2. In some aspects, the communication manager 140 includes a set of components, such as a measurement component 808. Alternatively, the set of components may be separate and distinct from the communication manager 140. In some aspects, one or more components of the set of components may include or may be implemented within one or more controllers/processors and/or one or more memories, of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The measurement component 808 may perform a plurality of cell measurements. The transmission component 804 may transmit a report that indicates a first quantity of cell measurements, of the plurality of cell measurements, associated with a first differential value relative to a particular cell measurement of the plurality of cell measurements, and a second quantity of cell measurements, of the plurality of cell measurements, associated with a second differential value relative to the particular cell measurement.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: performing a plurality of cell measurements; and transmitting a report that indicates: a first quantity of cell measurements, of the plurality of cell measurements, associated with a first differential value relative to a particular cell measurement of the plurality of cell measurements, and a second quantity of cell measurements, of the plurality of cell measurements, associated with a second differential value relative to the particular cell measurement.

Aspect 2: The method of Aspect 1, wherein the report includes a bitmap that indicates the first quantity of cell measurements and the second quantity of cell measurements.

Aspect 3: The method of Aspect 2, wherein a first binary value in the bitmap indicates a transition from the first differential value to the second differential value, and wherein a quantity of consecutive second binary values in the bitmap indicates the second quantity of cell measurements.

Aspect 4: The method of Aspect 2, wherein the bitmap is a truncated bitmap.

Aspect 5: The method of Aspect 2, further comprising compressing the bitmap prior to transmitting the report.

Aspect 6: The method of Aspect 5, wherein compressing the bitmap further comprises generating the bitmap via Huffman compression.

Aspect 7: The method of Aspect 5, wherein compressing the bitmap further comprises generating the bitmap via Huffman compression of a truncated bitmap.

Aspect 8: The method of any of Aspects 1-7, wherein the report includes a first part and a second part, wherein the first part indicates a size of the second part, and wherein the second part indicates the first quantity of cell measurements and the second quantity of cell measurements.

Aspect 9: The method of any of Aspects 1-8, wherein the report includes a value that indicates the first quantity of cell measurements and the second quantity of cell measurements.

Aspect 10: The method of Aspect 9, wherein the value indicates a table index of a table, wherein the table index corresponds to a row of the table indicating the first quantity of cell measurements and the second quantity of cell measurements.

Aspect 11: The method of Aspect 10, wherein the row indicates a bitmap, wherein a first binary value in the bitmap indicates a transition from the first differential value to the second differential value, and wherein a quantity of consecutive second binary values in the bitmap indicate the second quantity of cell measurements.

Aspect 12: The method of Aspect 11, wherein each row of the table corresponds to a valid bitmap for indication of transitions between differential values and numbers of cell measurements.

Aspect 13: The method of Aspect 10, further comprising receiving a configuration associated with the table.

Aspect 14: The method of Aspect 10, further comprising generating the table.

Aspect 15: The method of any of Aspects 1-14, wherein the first differential value corresponds to a first range of cell measurement values and the second differential value corresponds to a second range of cell measurement values.

Aspect 16: The method of Aspect 15, wherein the first range of cell measurement values has a first size and the second range of cell measurement values has a second size different than the first size.

Aspect 17: The method of Aspect 15, further comprising receiving a configuration that indicates at least one of the first range of cell measurement values or the second range of cell measurement values.

Aspect 18: The method of any of Aspects 1-17, wherein the plurality of cell measurements comprises at least one of a reference signal received power measurement or a signal to interference and noise ratio measurement.

Aspect 19: The method of any of Aspects 1-18, wherein the first quantity of cell measurements comprises multiple cell measurements.

Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 21: An apparatus for wireless communication at a device, the apparatus comprising one or more memories and one or more processors coupled to the one or more memories, the one or more processors configured to cause the device to perform the method of one or more of Aspects 1-19.

Aspect 22: An apparatus for wireless communication, the apparatus comprising at least one means for performing the method of one or more of Aspects 1-19.

Aspect 23: A non-transitory computer-readable medium storing code for wireless communication, the code comprising instructions executable by one or more processors to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

Aspect 25: A device for wireless communication, the device comprising a processing system that includes one or more processors and one or more memories coupled with the one or more processors, the processing system configured to cause the device to perform the method of one or more of Aspects 1-19.

Aspect 26: An apparatus for wireless communication at a device, the apparatus comprising one or more memories and one or more processors coupled to the one or more memories, the one or more processors individually or collectively configured to cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled with the one or more memories, at least one processor of the one or more processors configured to cause the UE to:
perform a plurality of cell measurements; and
transmit a report that indicates:
a first quantity of cell measurements, of the plurality of cell measurements, associated with a first differential value relative to a particular cell measurement of the plurality of cell measurements, and
a second quantity of cell measurements, of the plurality of cell measurements, associated with a second differential value relative to the particular cell measurement.

2. The apparatus of claim 1, wherein the report includes a bitmap that indicates the first quantity of cell measurements and the second quantity of cell measurements.

3. The apparatus of claim 2, wherein a first binary value in the bitmap indicates a transition from the first differential value to the second differential value, and wherein a quantity of consecutive second binary values in the bitmap indicates the second quantity of cell measurements.

4. The apparatus of claim 2, wherein the bitmap is a truncated bitmap.

5. The apparatus of claim 2, wherein at least one processor of the one or more processors is further configured to cause the UE to compress the bitmap prior to transmitting the report.

6. The apparatus of claim 1, wherein the report includes a first part and a second part,
wherein the first part indicates a size of the second part, and
wherein the second part indicates the first quantity of cell measurements and the second quantity of cell measurements.

7. The apparatus of claim 1, wherein the report includes a value that indicates the first quantity of cell measurements and the second quantity of cell measurements.

8. The apparatus of claim 7, wherein the value indicates a table index of a table, wherein the table index corresponds to a row of the table indicating the first quantity of cell measurements and the second quantity of cell measurements.

9. The apparatus of claim 8, wherein the row indicates a bitmap,
wherein a first binary value in the bitmap indicates a transition from the first differential value to the second differential value, and
wherein a quantity of consecutive second binary values in the bitmap indicate the second quantity of cell measurements.

10. The apparatus of claim 8, wherein the one or more processors are further configured to cause the UE to receive a configuration associated with the table.

11. The apparatus of claim 1, wherein the first differential value corresponds to a first range of cell measurement values and the second differential value corresponds to a second range of cell measurement values.

12. The apparatus of claim 11, wherein the first range of cell measurement values has a first size and the second range of cell measurement values has a second size different than the first size.

13. A method of wireless communication performed by a user equipment (UE), comprising:
performing a plurality of cell measurements; and
transmitting a report that indicates:
a first quantity of cell measurements, of the plurality of cell measurements, associated with a first differential value relative to a particular cell measurement of the plurality of cell measurements, and
a second quantity of cell measurements, of the plurality of cell measurements, associated with a second differential value relative to the particular cell measurement.

14. The method of claim 13, wherein the report includes a bitmap that indicates the first quantity of cell measurements and the second quantity of cell measurements, wherein a first binary value in the bitmap indicates a transition from the first differential value to the second differential value, and wherein a quantity of consecutive second binary values in the bitmap indicates the second quantity of cell measurements.

15. The method of claim 13, wherein the report includes a value that indicates the first quantity of cell measurements and the second quantity of cell measurements.

16. The method of claim 15, wherein the value indicates a table index of a table, wherein the table index corresponds to a row of the table indicating the first quantity of cell measurements and the second quantity of cell measurements.

17. The method of claim 16, wherein the row indicates a bitmap,
wherein a first binary value in the bitmap indicates a transition from the first differential value to the second differential value, and
wherein a quantity of consecutive second binary values in the bitmap indicate the second quantity of cell measurements.

18. The method of claim 13, wherein the first differential value corresponds to a first range of cell measurement values and the second differential value corresponds to a second range of cell measurement values, wherein the first range of cell measurement values has a first size and the second range of cell measurement values has a second size different than the first size.

19. A non-transitory computer-readable medium storing a set of instructions for wireless communication, the set of instructions comprising:
one or more instructions that, when executed by one or more processors of a user equipment (UE), cause the UE to:
perform a plurality of cell measurements; and
transmit a report that indicates:
a first quantity of cell measurements, of the plurality of cell measurements, associated with a first differential value relative to a particular cell measurement of the plurality of cell measurements, and
a second quantity of cell measurements, of the plurality of cell measurements, associated with a second differential value relative to the particular cell measurement.

20. The non-transitory computer-readable medium of claim 19, wherein the first differential value corresponds to a first range of cell measurement values and the second differential value corresponds to a second range of cell measurement values, and wherein the first range of cell measurement values has a first size and the second range of cell measurement values has a second size different than the first size.
